(19) United States
(12) Patent Application Publication
(10) Pub. No.: US 2019/0255986 A1
(43) Pub. Date: Aug. 22, 2019

(54) TRANSPORTATION LOAD SECURING SYSTEM

(71) Applicant: ROBIN WILKERSON, ODESSA, TX (US)

(72) Inventor: ROBIN WILKERSON, ODESSA, TX (US)

(21) Appl. No.: 15/762,522

(22) PCT Filed: Nov. 14, 2016
(86) PCT No.: PCT/US16/61899

§ 371 Date: Mar. 23, 2018

(51) Int. Cl. B60P 7/08

(52) U.S. Cl. CPC B60P 7/0884

(57) ABSTRACT

A load securing system having a load securing assembly including a load securing member having a bottom-side, a top-side, a right-side, a left-side, a first-end, and a second-end, a first fastener, and a second fastener; wherein the load securing assembly includes the load securing member, and the first fastener and the second fastener in functional combination. The load securing member is structured and arranged to be coupled to a decking surface via the first fastener and the second fastener, the load securing member providing a stable resting surface for a payload. The load securing member may be coupled to lugs and/or chalks for hauling various shaped loads.

### BACKGROUND OF THE INVENTION

### 1. Field of the Invention

The present invention relates generally to the field of load securing means and more specifically relates to a load securing system.

### 2. Description of Related Art

Many goods are transported via tractors or tractor-trailer units between locations. Tractors (large highway trucks) may have decks on them or tractors may pull trailers with decks (flat decks). Goods such as lumber may be stacked on the decks and tied in place using dunnage. Dunnage normally is old wood that is tied down to the deck and used to secure the loaded goods from shifting during transport. Dunnage may be expensive and doesn't typically have a long life of use since it isn't weather resistant. Weather causes the dunnage to crack, warp or split and is thereafter not safe for use. It is desirable that a solution be forthcoming to solve this problem and to thereby increase cost-effectiveness of truckers and road safety. It is also a desire to provide an environmentally friendly solution.

Several attempts have been made to solve the above-mentioned problems, which are herein incorporated by reference for their supportive teachings, such as those found in U.S. Pat. No. 5,693,163 to Gregory A. Hoover et al., U.S. Pat. No. 3,414,140 to John G Feldkamp. This art is representative of load securing means. However, none of the above inventions and patents, taken either singly or in combination, is seen to describe the invention as claimed.

### BRIEF SUMMARY OF THE INVENTION

In view of the foregoing disadvantages inherent in the known load securing means art, the present invention provides a novel load securing system. The general purpose of the present invention, which will be described subsequently in greater detail is to provide a safe and effective means for preventing payload from shifting while in transport on trailers or truck decks and the like.

In one embodiment of the invention there is a load securing system comprising: a load securing member having, a bottom-side, a top-side, a right-side, a left-side, a first-end having a first aperture, and a second-end having a second aperture, a first and a second fastener; wherein said load securing assembly comprises said load securing member, and said first fastener and said second fastener in functional combination; wherein said load securing member is defined by said bottom-side, said top-side, said right-side, said left-side, said first-end, and said second-end; and wherein said load securing member is structured and arranged to be coupled to a decking surface via said first fastener and said second fastener, said first fastener able to be received by said first aperture, and said second fastener able to be received by said second aperture, said load securing member providing a stable resting surface for a payload.

There has thus been outlined, rather broadly, the more important features of the invention in order that the detailed description thereof that follows may be better understood and in order that the present contribution to the art may be better appreciated.

### BRIEF DESCRIPTION OF THE ILLUSTRATED INVENTION

To further clarify various aspects of some example embodiments of the present invention, a more particular description of the invention will be rendered by reference to specific embodiments thereof that are illustrated in the appended drawing, in which:

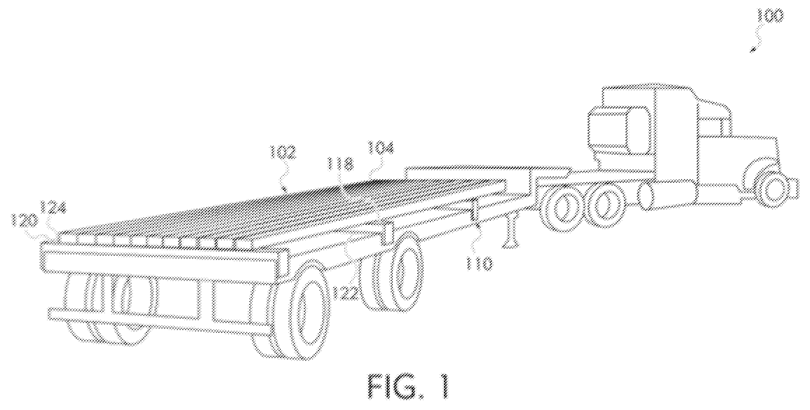

FIG. 1 shows a perspective view illustrating a load securing system during an ‘in-use’ condition according to an embodiment of the disclosure.

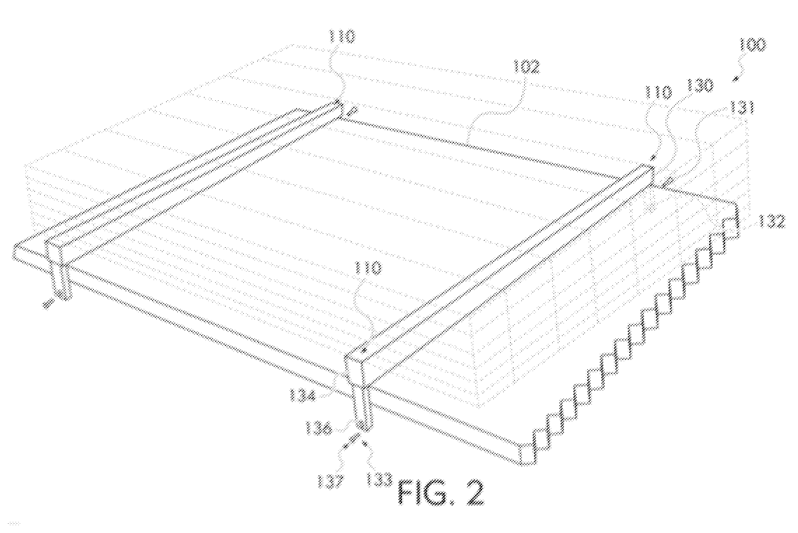

FIG. 2 is a perspective view illustrating the load securing system comprising a load securing assembly according to an embodiment of the present invention of the disclosure.

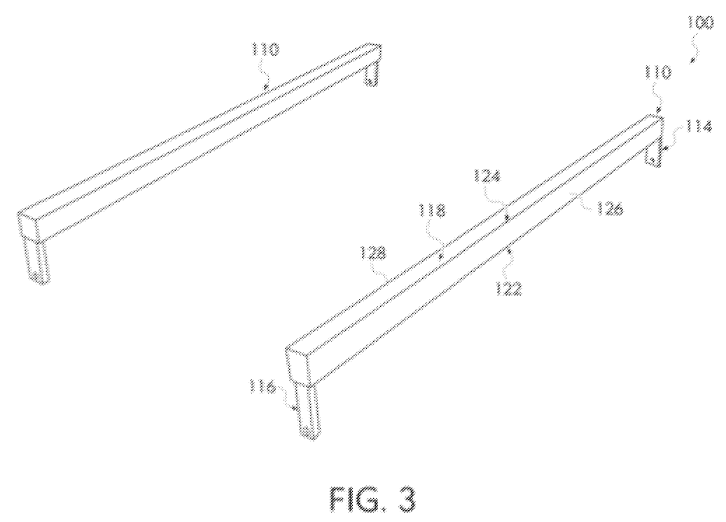

FIG. 3 is a perspective view illustrating the load securing assembly of the load securing system according to an embodiment of the present disclosure.

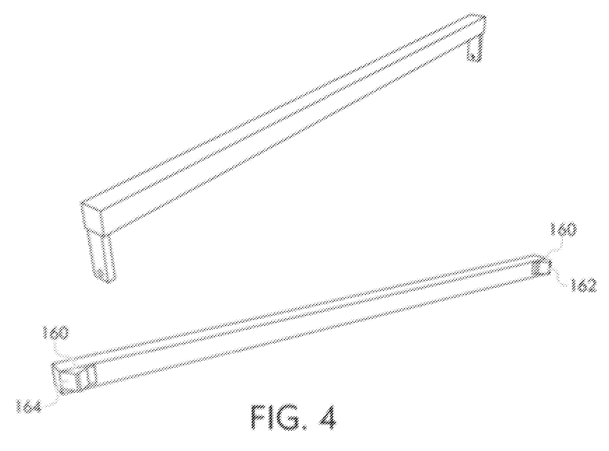

FIG. 4 is a perspective view illustrating load securing assembly according to an embodiment of the present disclosure.

### DETAILED DESCRIPTION OF THE ILLUSTRATED EMBODIMENTS

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

As discussed above, embodiments of the present disclosure relate to a load securing means and more particularly to a load securing system as used to improve the efficiency of securing loads during transport.

Referring now more specifically to the drawings by numerals of reference there is shown in FIGS. 1-4, various views of load securing system 100. Load securing system 100 comprises load securing assembly 110 having bottom-side 122, top-side 124, right-side 126, left-side 128, first-end 130 having first aperture 132, and second-end 134 having second aperture 136, first fastener 131, and second fastener 137; wherein load securing assembly 110 comprises a first fastener 131 and second fastener 137 in functional combination.

Referring now in more particular to FIG. 2, the load securing system 110 is defined by bottom-side 122, top-side 124, right-side 126, left-side 128, first-end 130, and second-end 134. Load securing system 110 is structured and arranged to be coupled to decking surface 102 of a truck via first fastener 131 and second fastener 137; first fastener 131 able to be received by first aperture 132, and second fastener 137 able to be received by second aperture 136; load securing member 110 providing a stable resting surface for payload 104. Payload 104 may comprise lumber or such shaped transportable materials. Load securing member 110 may further comprise gripping surface 118 on a (rough surface material) top-side 124 such that the friction coefficient is increased between load securing member 110 and payload 104; bottom-side 122 of load securing member 110 located adjacent decking surface 102 during use. Load securing member 110 is substantially planar.

Load securing member 110 in all embodiments preferably comprises a length of 100½ inches and preferably a 4 inch by 4 inch profile. Other dimensions may be used. Decking surface 102 as disclosed herein refers to a trailer, truck-deck or the like. Decking surface 102 is able to accept use of four of load securing member(s) 110 to secure payload 104.

Referring now more particularly to FIG. 3, in another alternative embodiment, load securing system 100 comprising load securing assembly 110 may comprise first-lug 114 and second-lug 116 each having a respective first and second aperture, and integral to load securing member 110. First-lug 114 and second-lug 116 extend downwardly from load securing member 110 such that first and second apertures are located below a plane of load securing member 110 when coupled atop decking surface 102. First-lug 114 and second-lug 116 each preferably comprise a respective lug-length of 7½ inches. Load securing member 110 preferably comprises grooves. The grooves may be ⅜ inch deep and wide and preferably located 2¼ inches from each end. Grooves may be spaced every two feet. First-lug 114 and second-lug 116 may comprise dimensions having a length of about 7½ inches, a width of about 3 inches and thickness of ½ inch.

Referring more specifically to FIG. 4, certain embodiments may comprise at least one chalking-member 160; wherein in these embodiments load securing assembly 110 comprises load securing member 110, the at least one chalking-member 160. The at least one chalking-member 160 (preferably two per load securing assembly 110) is removably couplable with load securing member 110, one at each opposing respective end, as shown. In this embodiment load securing member 110 gives a stable resting surface on decking surface 102 (above decking surface 102) for payload 104. The at least one chalking-member 160 may comprise exactly first-chalking-member 162, and second-chalking-member 164; wherein first-chalking-member 162, and second-chalking-member 164 each form an apex uprightly positioned during use to prevent pipe for example from shifting during transport of payload 104.

A half-inch hole, forming the apertures, may be placed in each of the lugs about one inch from the bottom suitable for a pin or a lock. First-chalking-member 162 and second-chalking-member 164 may comprise dimensions of two inches tall, and 3½ inches wide by 3 inches long. Tip-to-tip distance between first-chalking-member 162 and second-chalking-member 164 is about 96 inches when installed. The device may comprise sliding tracks for adjustability according to loads carried. Load securing member 110 preferably comprises plastic (or other suitable composite or other material) such that it is effectively weatherproof, and durable in use. Load securing member 110 may be attached adjacent decking surface 102 or at a desired distance above decking surface 102.

Load securing system 100 may be sold as a kit comprising the following parts: at least one load securing assembly 110; at least one chalking-member 160; and at least one set of user instructions. The kit has instructions such that functional relationships are detailed in relation to the structure of the invention (such that the invention can be used, maintained, or the like in a preferred manner).

Load securing system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different attachment means and combinations, parts may be sold separately, etc., may be sufficient.

What is claimed is new and desired to be protected by Letters Patent is set forth in the appended claims:

1. A load securing system comprising:
a) a load securing member having, a bottom-side, a top-side, a right-side, a left-side, a first-end having a first aperture, and a second-end having a second aperture,
b) a first and a second fastener;
c) wherein said load securing assembly comprises said load securing member, and said first fastener and said second fastener in functional combination;
d) wherein said load securing member is defined by said bottom-side, said top-side, said right-side, said left-side, said first-end, and said second-end; and
e) wherein said load securing member is structured and arranged to be coupled to a decking surface via said first fastener and said second fastener, said first fastener able to be received by said first aperture, and said second fastener able to be received by said second aperture, said load securing member providing a stable resting surface for a payload.

2. The load securing system of claim 1 wherein said load securing member further comprises a gripping surface on said top-side such that friction coefficient is increased between said load securing member and said payload, said bottom-side of said load securing member located adjacent said decking surface during use.

3. The load securing system of claim 2 wherein said load securing member is substantially planar.

4. The load securing system of claim 1 wherein said first fastener comprises a first studded pin.

5. The load securing system of claim 1 wherein said second fastener comprises a second studded pin.

6. The load securing system of claim 5 wherein said load securing member comprises plastic such that it is effectively weatherproof, and durable in use.

7. A load securing system comprising:
a) a load securing member having, a bottom-side, a top-side, a right-side, a left-side, a first-end having a first aperture, and a second-end having a second aperture;
b) at least one chalking-member; and
c) a first and a second fastener;
d) wherein said load securing assembly comprises said load securing member, said at least one chalking-member, and said first fastener and said second fastener in functional combination;
e) wherein said load securing member is defined by said bottom-side, said top-side, said right-side, said left-side, said first-end, and said second-end; and
f) wherein said at least one chalking-member is removably couplable with said load securing member, and
g) wherein said load securing member is structured and arranged to be coupled to a decking surface via said first fastener and said second fastener, said first fastener able to be received by said first aperture, and said second fastener able to be received by said second aperture, said load securing member providing a stable resting surface for a payload.

8. The load securing system of claim 7 wherein said at least one chalking-member comprises exactly a first-chalking-member, and a second-chalking-member.
